(19) United States
(12) Patent Application Publication
(10) Pub. No.: US 2019/0353922 A1
(43) Pub. Date: Nov. 21, 2019

(54) STEMLESS MOUNTING SYSTEM FOR AN EYEWEAR LENS

(71) Applicant: James D. Castillo, Los Alamos, CA (US)

(72) Inventor: James D. Castillo, Los Alamos, CA (US)

(21) Appl. No.: 16/526,846

(22) Filed: Jul. 30, 2019

Related U.S. Application Data
(63) Continuation of application No. 15/669,144, filed on Aug. 4, 2017.
(60) Provisional application No. 62/372,149, filed on Aug. 8, 2016.

(51) Int. Cl. G02C 5/12; G02C 3/00; G02C 5/16; G02C 5/04

(52) U.S. Cl. CPC G02C 5/128; G02C 3/003; G02C 2200/02; G02C 5/04; G02C 5/16

(57) ABSTRACT

A system for mounting an eyewear lens on a user. The system includes a pair of nasal appliques, a bridge member, and a pair of lateral compression elements, with the bridge member and compression elements being attachable to an eyewear lens. The bridge member is magnetically engageable to the nasal appliques to limit translatable movement of the lens relative to the user, while the compression elements compress against opposed sides of the users head to mitigate pivotal movement of the lens relative to the user.

### CROSS-REFERENCE TO RELATED APPLICATIONS

The present application claims priority to U.S. Provisional Application No. 62/372,149, filed, Aug. 8, 2016, the contents of which are expressly incorporated herein by reference.

### STATEMENT RE: FEDERALLY SPONSORED RESEARCH/DEVELOPMENT

Not Applicable

### BACKGROUND

### 1. Technical Field

The present disclosure relates generally to a system for securing an eyewear lens on a user's face, and in particular, an armless system which utilizes lateral compression elements and magnetic nasal appliques.

### 2. Description of the Related Art

Eyewear lenses are worn for a number of different purposes, including but not limited to, corrective vision, protection from the sun or other environmental conditions, as well as to enhance vision during sports or other activities. The lenses may be prescription lenses, or alternatively, non-prescription lenses. In either case, the eyewear lenses are typically coupled to a conventional frame, which is designed to hold the eyewear lenses over the user's face, and specifically, in optical alignment with the user's eyes. Thus, when the user's eyes are open, the user can easily look through the lenses.

A conventional frame for holding eyewear lenses typically includes a forward section, which extends around at least a portion of the lenses and defines a bridge which rests on the user's nose. A pair of stems or arms are pivotally coupled to respective lateral ends of the forward section, with each arm being configured to extend from the forward section and rest on a respective one of the user's ears.

One downside to conventional eyewear frames is that they lack widespread aesthetic appeal. In particular, the arms extending between the lenses and the user's ears oftentimes create an undesirable look, particularly from a side profile view. Furthermore, the constant contact of the frame on the user's nose, as well as on the user's ears may create an uncomfortable, bulky feel for the user. Conventional eyewear frames, particularly the arms, also tend to interfere with hats, helmets, and headphones. The eyewear frame arms are also susceptible to bending or breaking, which may require replacement of the entire frame.

Accordingly, there is a need in the art for an improved system for securing an eyewear lens to a user which creates a more aesthetically pleasing appearance, and provides a more comfortable feel when worn. Various aspects of the present disclosure address this particular need, as will be discussed in more detail below.

### BRIEF SUMMARY

Various aspects of the present disclosure are directed to a “stemless” or “armless” eyewear system. In this regard, the eyewear is maintained on the user's head, at least partially, through a pair of lateral compression elements which comfortably engage with the temple regions of the user's head to maintain the eyewear in proper position on the user's face. Accordingly, the stemless eyewear system provides a more aesthetically and functionally appealing alternative to conventional eyewear frames.

According to one embodiment, there is provided an eyewear system for use with a pair of nasal appliques. The eyewear system includes an eyewear component configured to be placeable in alignment with a user's eyes and magnetically engageable with the pair of nasal appliques. A pair of compression elements are coupled to respective lateral regions of the eyewear component. The pair of compression elements are adapted to engage with respective lateral regions of a user's head to generate a friction force between the pair of compression elements and the user's head to secure the eyewear component to the user's head.

The magnetic engagement between the eyewear component and the pair of nasal appliques may mitigate translation of the eyewear component relative to the user's head. The engagement between the pair of compression elements and the user's head may mitigate pivotal movement of the eyewear component about the pair of nasal appliques.

Each of the pair of compression elements may include at least one flex arm and at least one pad coupled to the at least one flex arm.

Each of the pair of compression elements may include a plurality of flex arms and a plurality of pads coupled to respective ones of the plurality of flex arms. The plurality of flex arms may be independently moveable relative to each other.

Each compression element may include a rigid body coupled to the eyewear component and a flexible body coupled to the rigid body. The compression element may be transitional relative to the rigid body between a neutral position and a compressed position, with the flexible body moving toward the rigid body as the flexible body transitions from the neutral position toward the compressed position.

Each compression element may include a first wall and a second wall angled relative to the first wall to define a wedge-shape.

Each compression element may be detachably coupled to the eyewear component.

The eyewear component may include a lens. The lens may be adapted to extend over the user's eyes.

The eyewear component may include an adjustable bridge section configured to be engageable with the pair of nasal appliques. The adjustable bridge section may include a pair of arms, and the adjustable bridge section may be transitional between a first configuration and a second configuration. A distance between the arms may increase as the adjustable bridge transitions from the first configuration to the second configuration.

The eyewear component may be formed independent of arms that extend over ears of the user.

According to another embodiment, there is provided an armless eyewear system comprising an eyewear component positionable over eyes of the user, and a pair of compression elements engageable with the eyewear component. The pair of compression elements are configured to compress against the head of the user when the eyewear component is positioned over the eyes of the user and apply opposing compressive forces on the head of the user to mitigate movement of the eyewear component relative to the head of the user.

In accordance with another embodiment of the present disclosure, there is provided a system for mounting an eyewear lens on a user. The system includes a pair of nasal appliques, a bridge member, and a pair of lateral compression elements, with the bridge member and compression elements being attachable to an eyewear lens. The bridge member is magnetically engageable to the nasal appliques to limit translatable movement of the lens relative to the user, while the compression elements compress against opposed sides of the users head to mitigate pivotal movement of the lens relative to the user.

The system is configured to enable securement of the eyewear lens to the user without the use of conventional eyewear frame arms which extend over the user's ears.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is an upper perspective view of an eyewear system including a pair of lateral compression elements connected to a glasses lens having an adjustable bridge device coupled thereto;

FIG. 2 is a front view of a user's nose having a pair of nasal appliques adhered thereto;

FIG. 3 is a side view of the user's nose depicting one of the pair of nasal appliques adhered thereto;

FIG. 4 is a front view of a user wearing the eyewear system of FIG. 1;

FIG. 5 is a side view of the eyewear system with a profile of a user depicted in phantom;

FIG. 6 is an enlarged top view depicting a lateral compression element in a relaxed/neutral configuration;

FIG. 7 is an enlarged top view depicting the lateral compression element in a partially compressed configuration;

FIG. 8 is an enlarged top view depicting a lateral compression element in a fully compressed configuration;

FIG. 9 is a side view of a compressive component of the lateral compressive element in the relaxed configuration;

FIG. 10 is an upper perspective view of the lateral compressive component of FIG. 9 in the relaxed configuration;

FIG. 11 is a rear view of a second embodiment of an eyewear system including a pair of lateral compression elements connected to a glasses lens having an adjustable bridge device coupled thereto;

FIG. 12 is an enlarged rear view of one of the pair of lateral compression elements depicted in FIG. 11;

FIG. 13 is an upper perspective view of the eyewear system depicted in FIG. 11;

FIG. 14 is a top view of a third embodiment of a lateral compression element connected to a glasses lens; and

FIGS. 15 and 16 are top views depicting the lateral compression element in various stages of compression.

Common reference numerals are used throughout the drawings and the detailed description to indicate the same elements.

### DETAILED DESCRIPTION

The detailed description set forth below in connection with the appended drawings is intended as a description of certain embodiments of an armless attachment system for a glasses lens and is not intended to represent the only forms that may be developed or utilized. The description sets forth the various structure and/or functions in connection with the illustrated embodiments, but it is to be understood, however, that the same or equivalent structure and/or functions may be accomplished by different embodiments that are also intended to be encompassed within the scope of the present disclosure. It is further understood that the use of relational terms such as first and second, and the like are used solely to distinguish one entity from another without necessarily requiring or implying any actual such relationship or order between such entities.

Referring now to the drawings, wherein the showings are for purposes of illustrating a preferred embodiment of the present disclosure only, and are not for purposes of limiting the same, there is depicted a system for attaching an eyewear lens 10 to a wearer in a conventional wearing position. The system is specifically adapted to allow for such attachment without the use of a conventional stems or arms which extend from the lens 10 and over the wearer's ears. Rather, the system for attaching the eyewear lens 10 to the wearer uniquely employs a pair of nasal appliques 12 and a pair of lateral compression elements 14 which compress against the opposed temple regions of the user's head. As will be described in more detail below, attachment of the lens 10 to the magnetic appliques 12 is through magnetic force, which prevents the lens 10 from sliding down over the user's nose, while the compression elements 14 frictionally engage with the sides of the user's head to prevent rotation of the lens 10 about the nasal appliques 12.

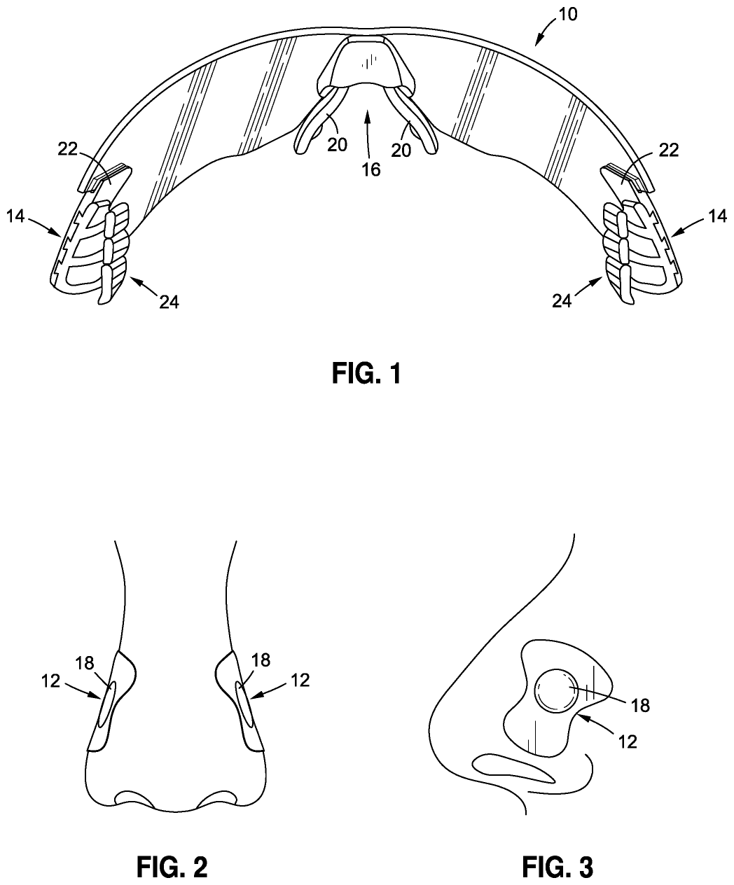

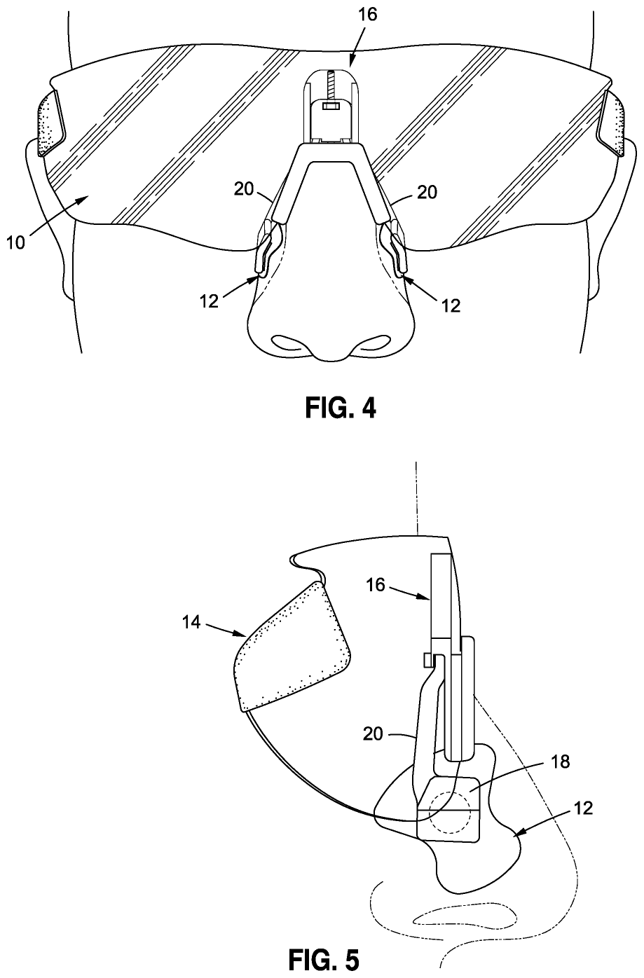

FIG. 1 is a top view of an exemplary lens 10 having an adjustable bridge device 16 coupled to a bridge region of the lens 10, and the pair of compression elements 14 are coupled to respective lateral regions of the lens 10. FIGS. 2 and 3 depict an exemplary embodiment of a nasal applique 12, as well as an exemplary placement of the nasal appliques 12 on the user's nose. The nasal appliques 12 are preferably adhesively applied to opposing lateral portions of the user's nose. Each nasal applique 12 includes a metallic element 18 located between a flexible base layer and a cover layer. The flexible base layer includes an adhesive which allows the base layer to be selectively adhered to the user's nose. As can be seen in FIGS. 2-5, the appliques 12 are preferably placed adjacent the user's nostril to allow for dilation of the nostril in response to the magnetic interaction between the applique 12 and the bridge device 16.

The nasal appliques 12 magnetically interact with respective arms 20 on the bridge device 16. The arms 20 are transitional relative to the lens 10 to modify a magnitude of the dilating force applied to the user's nose. In the embodiment depicted in FIGS. 1 and 4-5, the arms 20 are pivotable relative to the lens 10 to adjust the angle between the arms 20, which allows the user to size the bridge device 16 to the particular anatomy of the user, as well as to adjust a dilating force imparted on the user's nose. In particular, as the size of the angle increases, the magnitude of the dilating force also increases, and conversely, as the size of the angle decreases, the magnitude of the dilating force also decreases.

For more information regarding the nasal appliques 12, as well as the bridge device 16 (i.e., a “lens mounting device”), please refer to U.S. Patent Application Publication No. 2016/0193070, entitled Eyewear System For Securing Lens On A User's Nose And Dilating User's Nose, as well as U.S. Patent Application Publication No. 2016/0106567, entitled Nasal Applique and Related Applicator for Applying Applique to a Nose of a Wearer, the contents of both of which are expressly incorporated herein by reference.

When the bridge device 16 is magnetically coupled with the pair of nasal appliques 12, the lens 10 is effectively prevented from translational movement relative to the user, i.e., sliding down the user's nose. However, the bridge device 16 remains free to pivot about the contact points between the bridge device 16 and the nasal appliques 12. Thus, in order to inhibit such pivotal movement, the lateral compression elements 14 are adapted to frictionally engage with the user's head, wherein the frictional force counteracts the urge of the lens 10 to pivot, thereby securing the lens 10 to the user so as to substantially eliminate any relative movement of the lens 10 relative to the user during use.

Referring now to FIGS. 1, and 6-8, a first embodiment of the compression element 14 is shown, which includes a rigid base 22 directly attached to the lens 10, and a flexible component 24 which is attachable to the rigid base 22. The rigid base 22 is adapted to facilitate connection of the compression element 14 to the lens 10, while the flexible component 24 is adapted to interface with the user to provide the frictional force for securing the lens 10 in proper position during use. The rigid base 22 includes an inner portion extending along an inner surface of the lens 10, an outer portion extending along an outer surface of the lens 10, and an upper portion extending between the inner and outer portions along an upper surface or edge of the lens 10. The rigid base 22 may be molded over a respective lateral portion of the lens 10 to secure the rigid base 22 to the lens 10, although it is contemplated that the rigid base 22 may be adhered or otherwise secured to the lens 10.

Although the present disclosure provides a description and depiction of one embodiment of a rigid base, the scope of the present disclosure is not limited thereto. In this regard, the term “rigid base” may refer to any structure or mechanism, such as adhesive, that connects the flexible component 24 to the lens 10.

According to one embodiment, the flexible component 24 includes a primary wall 26 and a plurality of connector ribs 28 extending along a first side of the primary wall 26, with the connector ribs 28 being configured to cooperatively engage with corresponding grooves 29 formed in the rigid base 22. In the exemplary embodiment, the connector ribs 28 and corresponding grooves 29 form a dovetail joint to connect the flexible component 24 to the rigid base 22. The interconnection between the rigid base 22 and the flexible component 24 may be generally permanent, or alternatively, temporary, to enable interchanging of flexible components 24 with a single rigid base 22. It is also contemplated that the flexible component 24 may attach directly to the lens 10 without the need of the rigid base 22.

The flexible component 24 further includes a plurality of flex arms 30 extending from a second side of the primary wall 26, with each flex arm 30 having a gripping pad 32 coupled to, or located at, a distal end portion thereof. According to one embodiment, the size and shape of the flex arm 30 and the gripping pads 32 included in the flexible component 24 may differ to accommodate the curvature of the lens 10 and are capable of extending toward the user to engage with the user's head.

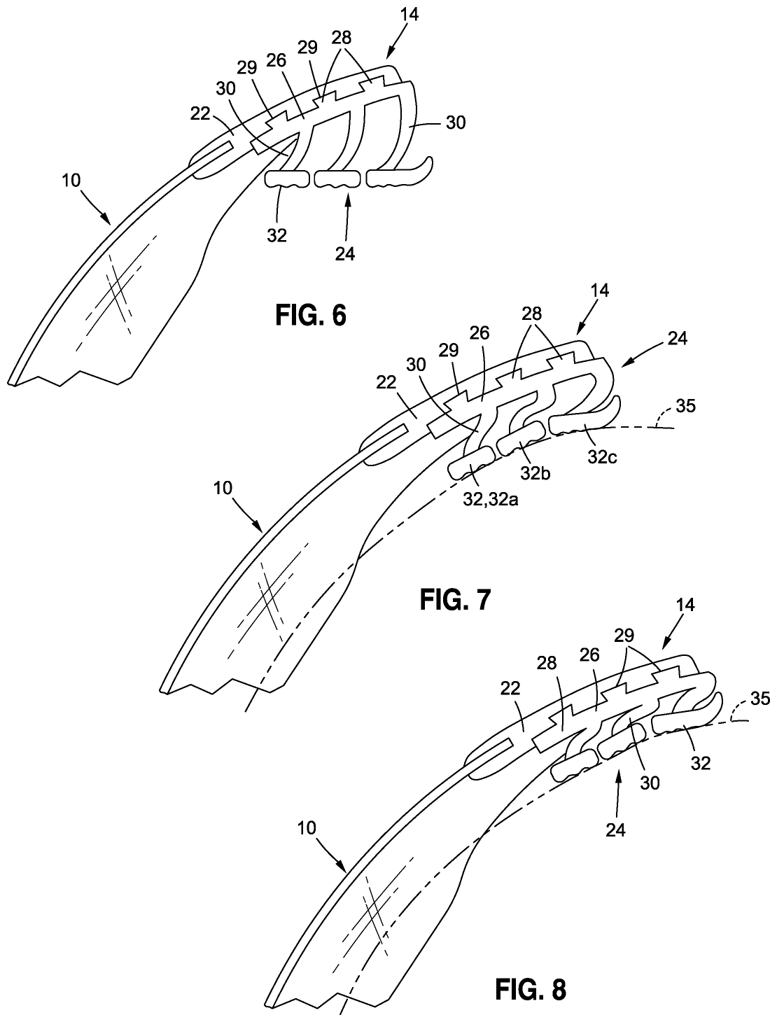

FIGS. 6-8 show different levels of compression of the flexible component 24 as the flexible component 24 interfaces with the user's face. A phantom line 35 is depicted in FIGS. 7 and 8 to represent an exemplary contour of a user's face. The flexible component 24 is configured to be selectively transitional between a neutral position, as shown in FIG. 6, to a fully compressed position, as shown in FIG. 8. FIG. 7 shows a partially flexed position between the neutral position of FIG. 6 and the fully compressed position of FIG. 8. Compression of the flexible component 24 against the user increases the frictional force between the flexible component 24 and the user to mitigate pivoting movement of the lens 10 relative to the user. When the flexible component 24 transitions from the neutral position toward the flexed position, the gripping pads 32 are moved toward to the primary wall 26, and the flex arms 30 are either bent or moved toward the primary wall 26. Each flex arm-gripping pad assembly is configured to be independently moveable relative to the other flex arm-gripping pad assemblies, which allows the flexible component 24 to conform to the unique contour of the user. The flexible component 24 is configured to have sufficient internal resiliency, such that it is biased toward the neutral position. This biasing force urges the flexible component toward the user to generate the frictional force between the user and the flexible component 24.

The gripping pads 32 are independent of one another, and thus, may move relative to each other. In particular, the gripping pads 32 may move toward the primary wall 26 as they are transitioned from the neutral position toward the flexed position. Accordingly, the gripping pads 23 may be specifically configured to enable such relative movement. The plurality of gripping pads 32 include a medial gripping pad 32a, an intermediate gripping pad 32b, and a lateral gripping pad 32c. Since the intermediate and lateral gripping pads 32b, 32c have an adjacent gripping pad in a medial direction, the medial end portions of such pads 32b, 32c may define a curved or arcuate configuration to facilitate relative movement between that gripping pad and the medially adjacent gripping pad.

It is contemplated that the gripping pads 32a-c may be of similar size and shape, or alternatively, of different size and shape. In one particular embodiment, the medial gripping pad 32a is smallest in size, the intermediate gripping pad 32b is intermediate in size, and the lateral gripping pad 32c is largest in size.

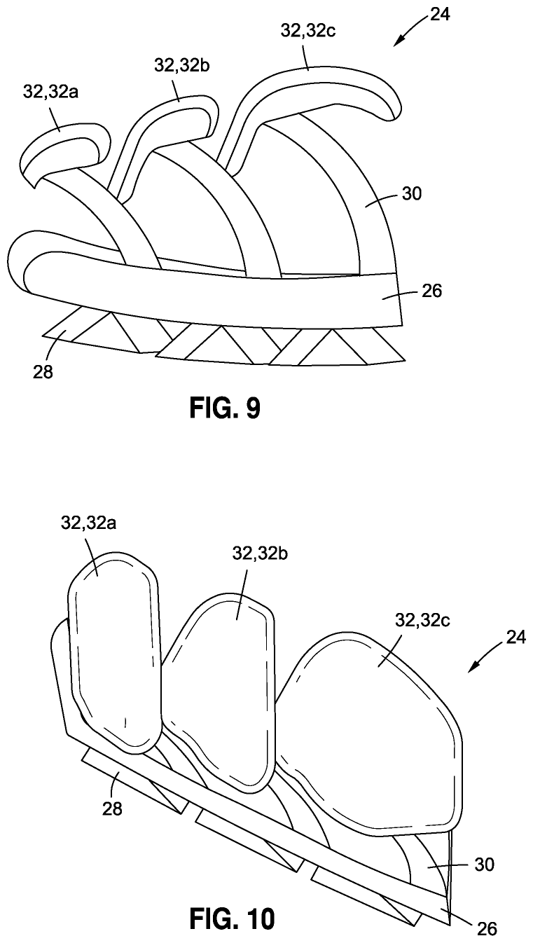

FIGS. 9 and 10 depict a side view and perspective view, respectively, of the flexible component 24 shown in FIGS. 6-8 and discussed above. The flexible component 24 is shown in FIGS. 9 and 10 as being removed or separated from the rigid base 22.

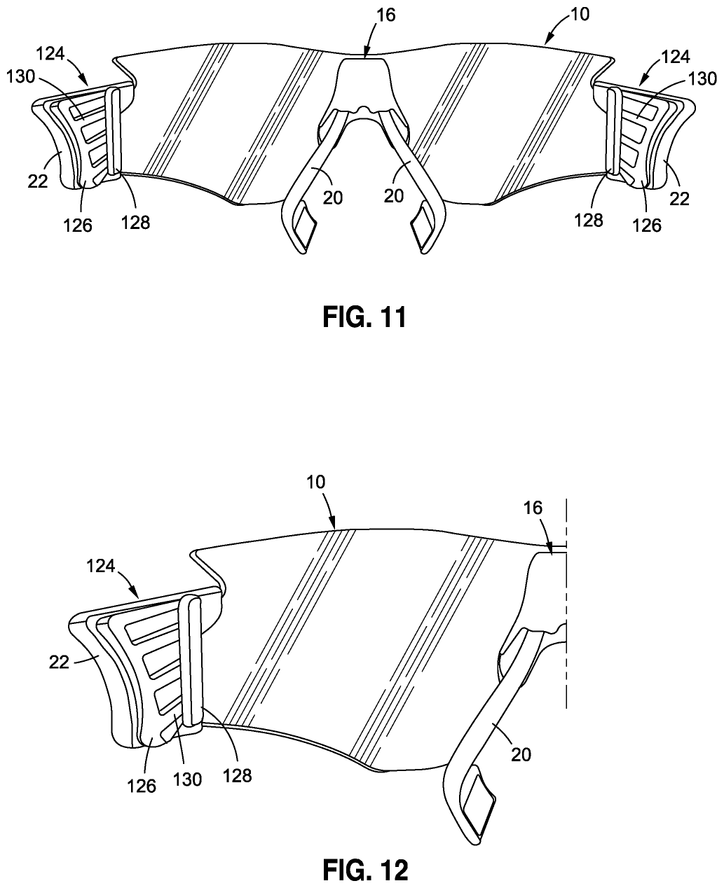

Turning now to FIGS. 11-16, there is depicted alternative embodiments of the lateral compression element. Common to the embodiment of the lateral compression element depicted in FIGS. 6-10 and the alternative embodiments of the lateral compression elements depicted in FIGS. 11-16 is a rigid base and a flexible component. The rigid bases shown in FIG. 11-16 is similar to the rigid base depicted in FIGS. 6-8, and thus the discussion of the rigid base 22 above, also applies to the rigid bases included in the embodiments depicted in FIG. 11-16. The primary difference from one embodiment to the next relates to the flexible component, and thus, the following discussion will be focused on the unique flexible components.

Referring now specifically to FIGS. 11-13, there is shown lens 10 having a pair of flexible components 124 coupled to respective lateral end portions thereof. Each flexible component 124 includes an inner wall 126, an opposing outer wall 128, and a plurality of flex arms 130 extending between the inner and outer walls 126, 128. In this regard, the flexible component 124 in FIGS. 11-13 differs from the flexible component 24 in FIGS. 6-10 because each flex arm 130 extends between the inner and outer walls 126, 128, whereas each flex arm 30 in the previous embodiment extended to a respective gripping pad 32. The inner and outer walls 126, 128 may be disposed in non-parallel relation to each other, and define a wedge shape, with the distance between the walls 126, 128 being smaller at a lower end of the walls 126, 128 (from the perspective shown in the Figures), and larger at a higher end of the walls 126, 128. The inner and outer walls 126, 128 are adapted to move relative to each other as the flexible component 124 transitions between neutral and compressed positions, with the outer wall 128 moving toward the inner wall 126 as the flexible component 124 transitions from the neutral position toward the compressed position. The flexible component 124 may be biased toward the neutral position, so as to compress against the user's head when transitioned to the compressed position. As the inner and outer walls 126, 128 move relative to each other, the flex arms 130 bend or flex from their generally straight, neutral position. The outer wall 128 is adapted to interface with the user and provide a frictional force against the user's head to mitigate movement of the lens 10 relative to the user's face.

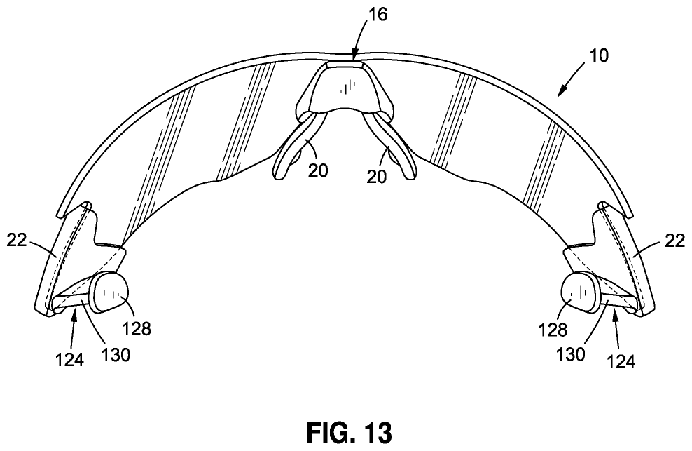

FIG. 13 shows a derivation of the flexible component 124, with the flexible component 124 only including a single flex arm 130 extending between a rigid base 22 and an outer wall 128. Thus, the flexible component 124 may include a single flex arm 130, or multiple flex arms 130.

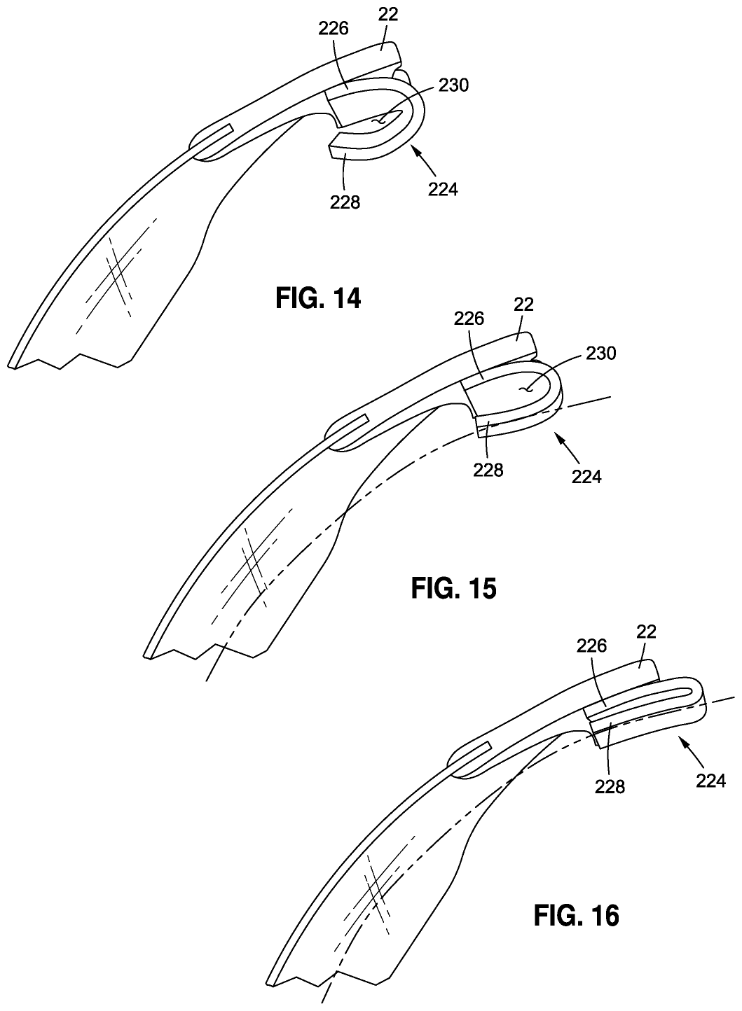

Referring now specifically to FIGS. 14-16, another embodiment of a flexible component 224 is shown attached to a rigid base 22. The flexible component 224 a folded body including an inner flap 226 and an outer flap 228 integrally formed with the inner flap 226. The inner and outer flaps 226, 228 may collectively define a central void 230. The flexible component 224 includes internal resiliency, which causes the inner and outer flaps 226, 228 to assume a spaced relation to one another, which defines a neutral position, when not being acted on by an outside force. The flexible component 224 is additionally configured to transition from the neutral position to a compressed position, with the outer flap 228 moving toward the inner flap 226 when transitioned from the neutral position toward the compressed position. As the flexible component 224 transitions from the neutral position toward the compressed position, the volume or size of the void 230 decreases. Due to the internal resiliency of the flexible component 224, the flexible component 224 is biased toward the neutral position. The outer flap 228 is configured to press against the user's head to create a friction force between the user's head and the outer flap to mitigate pivotal movement of the lens relative to the user.

The various flexible components described herein may be formed of a moldable, resilient, flexible material, such as urethane or other suitable materials known in the art. The material should have sufficient tack to skin to keep the gripping pads from sliding when the lens is urged to move away from the user's face.

The particulars shown herein are by way of example only for purposes of illustrative discussion, and are not presented in the cause of providing what is believed to be most useful and readily understood description of the principles and conceptual aspects of the various embodiments of the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. An eyewear system for use with a pair of nasal appliques, the eyewear system comprising:
an eyewear component configured to be placeable in alignment with a user's eyes and magnetically engageable with the pair of nasal appliques; and
a pair of compression elements coupled respective lateral regions of the eyewear component, the pair of compression elements being adapted to engage with respective lateral regions of a user's head to generate a friction force between the pair of compression elements and the user's head to secure the eyewear component to the user's head.

2. The eyewear system recited in claim 1, wherein:
the magnetic engagement between the eyewear component and the pair of nasal appliques mitigates translation of the eyewear component relative to the user's head;
the engagement between the pair of compression elements and the user's head mitigates pivotal movement of the eyewear component about the pair of nasal appliques.

3. The eyewear system recited in claim 1, wherein each of the pair of compression elements includes at least one flex arm and at least one pad coupled to the at least one flex arm.

4. The eyewear system recited in claim 1, wherein each of the pair of compression elements includes a plurality of flex arms and a plurality of pads coupled to respective ones of the plurality of flex arms.

5. The eyewear system recited in claim 4, wherein the plurality of flex arms are independently moveable relative to each other.

6. The eyewear system recited in claim 1, wherein each compression element includes a rigid body coupled to the eyewear component and a flexible body coupled to the rigid body, the compression element being transitional relative to the rigid body between a neutral position and a compressed position, the flexible body moving toward the rigid body as the flexible body transitions from the neutral position toward the compressed position.

7. The eyewear system recited in claim 1, wherein each compression element includes a first wall and a second wall angled relative to the first wall to define a wedge-shape.

8. The eyewear system recited in claim 1, wherein each compression element is detachably coupled to the eyewear component.

9. The eyewear system recited in claim 1, wherein the eyewear component includes a lens.

10. The eyewear system recited in claim 1, wherein the lens is adapted to extend over the user's eyes.

11. The eyewear system recited in claim 1, wherein the eyewear component includes an adjustable bridge section configured to be engageable with the pair of nasal appliques.

12. The eyewear system recited in claim 11, wherein the adjustable bridge section includes a pair of arms, the adjustable bridge section being transitional between a first configuration and a second configuration, a distance between the arms increasing as the adjustable bridge transitions from the first configuration to the second configuration.

13. The eyewear system recited in claim 1, wherein the eyewear component is formed independent of arms that extend over ears of the user.

14. An armless eyewear system comprising:
an eyewear component positionable over eyes of the user; and
a pair of compression elements engageable with the eyewear component, the pair of compression elements, being configured to compress against the head of the user when the eyewear component is positioned over the eyes of the user and apply opposing compressive forces on the head of the user to mitigate movement of the eyewear component relative to the head of the user.

15. The eyewear system recited in claim 14, wherein each of the pair of compression elements includes at least one flex arm and at least one pad coupled to the at least one flex arm.

16. The eyewear system recited in claim 14, wherein each of the pair of compression elements includes a plurality of flex arms and a plurality of pads coupled to respective ones of the plurality of flex arms.

17. The eyewear system recited in claim 14, wherein the plurality of flex arms are independently moveable relative to each other.

18. The eyewear system recited in claim 14, wherein each compression element includes a rigid body coupled to the eyewear component and a flexible body coupled to the rigid body, the compression element being transitional relative to the rigid body between a neutral position and a compressed position, the flexible body moving toward the rigid body as the flexible body transitions from the neutral position toward the compressed position.

19. The eyewear system recited in claim 14, wherein each compression element includes a first wall and a second wall angled relative to the first wall to define a wedge-shape.

20. The eyewear system recited in claim 14, wherein each compression element is detachably coupled to the eyewear component.
